(19) United States
(12) Patent Application Publication
(10) Pub. No.: US 2002/0103746 A1
(43) Pub. Date: Aug. 1, 2002

(54) Customizable group initiative

(76) Inventor: Robert P. Moffett JR., Rancho Palos Verdes, CA (US)

Correspondence Address: LIU & LIU LLP, 811 WEST SEVENTH STREET, SUITE 1100, LOS ANGELES, CA, 90017, US

(21) Appl. No.: 09/953,586

(22) Filed: Sep. 11, 2001

Related U.S. Application Data
(63) Continuation-in-part of application No. 60/231,619, filed on Sep. 11, 2000.

(51) Int. Cl. G06F 17/60

(52) U.S. Cl. 705/37

(57) ABSTRACT

A group initiative that enables the establishment and control of a group by members of the group, while allowing the personalized requirements of individual members to be maintained as the group pursues the advantages of the collective bargaining power of the group as a whole. One aspect of the present invention is a group initiative for collective bargaining for purchases. Buyers in a particular purchasing group maintain their individuality by defining differing purchasing requirements such as product or service specifications, contract terms, delivery schedules, etc. while they simultaneously present themselves as a cohesive and committed group to the seller community. Sellers also maintain individuality in responding to each buyer in the group with different pricing based on each buyer's requirements and buying profile considering such factors as volumes purchased, payment terms and cost of servicing each potential account in the group.

This is a continuation-in-part application of U.S. Provisional Application No. 60/231,619, filed Sep. 11, 2001

### BACKGROUND OF THE INVENTION

1. Field of the Invention

This invention relates generally to collective bargaining based on a group initiative, particularly to collective bargaining based on a group initiative structured over an information exchange network, and more particularly to a method and system for collective bargaining based on a group initiative structure utilizing the Internet.

2. Description of Related Art

Generally, compared to individual bargaining, collective bargaining can bring about more favorable results for a group initiative. The group initiative may be directed to the purchase of products or services, obtaining a better employee compensation package, or any other type of initiative that may benefit a group as a whole.

By way of example and not limitation, reference is made to a purchasing transaction. In a market driven economy, one of the expectations that customers have is to obtain the best pricing. Traditionally, the economics of supply and demand and the perceived value of the buyer businesses to the sellers establish the pricing of goods and services. Competition among sellers and/or volume purchases by buyers (assuming in a competitive supply environment) could potentially drive pricing down. Volume purchases may be effectively created by buyers teaming together to demand their aggregate purchasing of a particular product or service. Competition among sellers may be effectively created by presenting the purchase request of the group for bid by more than one seller.

With the fast growing and ubiquity of electronic commerce utilizing the Internet, group purchasing from a large seller community can be facilitated online. Buyers from far and near can relatively easily form groups to take advantage of volume purchasing, and/or to obtain bids from many potential sellers. In the past, many processes have been developed for creating and managing purchasing groups for online transactions. Generally, purchasing groups are monitored to determine if and when the size of the group or the aggregated purchase volume has reached a level associated with the seller's agreed volume discount pricing. The condition for group discount pricing may require that a certain number of buyers must have joined the group and commit to purchasing within a certain period of time.

The concept of managing groups for electronic commerce has been the subject of several recent patent publications. One example is PCT publication WO 00/43928 to Tachner, et al., which purportedly discloses a method and system that allow for low volume buyers to aggregate their purchasing power to gain high volume discounts. Vendors display information about their products and services along with a price schedule that provides greater discounts for bigger volume of purchases. Alternatively, the price paid by each buyer is the total value demanded by the vendor divided equally between all interested buyers. Buyers then aggregate online to take advantage of these volume discounts. Unlike an auction model, where more buyers mean higher prices, here more buyers lead to lower prices.

PCT publication WO 00/46727 to Alon, et al. purportedly describes a method and system that utilize a computer to facilitate a sales transaction between a group of buyers and at least one seller. Potential buyers may create a group organized for purchasing a product/service from one or more sellers. The computer system may output the buyers' collective request for the product/service to one or more sellers of the requested item. The sellers may respond by providing a price quotation for the requested item, often on the basis of the number of such items to be purchased by the group. The computer system notifies group members of the submitted seller quotations, in response to which some buyers may commit themselves to purchasing the item at the specified price or otherwise indicating a price at which they would be willing to commit to purchasing the item. Sellers may review the price quotations submitted by other sellers and submit competing price quotations. In a typical arrangement, an iterative process ensues in which sellers offer lower and lower prices for the requested products/services until reaching a point at which one or more buyers in the group are sufficiently comfortable with the price to commit themselves to purchasing the product/service.

PCT publication WO 01/02992 to Van Horn, et al. purportedly describes a more elaborate method and system that enable partner sites to join in the sale of products/services via a PowerBuy business method. A seller registers a list of products/services to be displayed on partner sites. Customers/visitors who access partner sites may link to one or more PowerBuys conducted on an owner's main site. Accordingly, the method and system enable a super demand aggregation for product/services offered for sale by the PowerBuy business method. A partner menu tree is provided which allows partners to pre-select products/categories for display to customers linking to the PowerBuy from their partner site. Sellers may provide particular products, services, categories, and abstract terms to help partners select which products/services to display for customers from among all the PowerBuy products/services.

Also, in PCT publication WO 00/75839 to Pishevar et al., a collective procurement management system purportedly permits multiple potential purchasers of a specific item or service to submit orders for the item or service on an ongoing basis. As orders enter the system, they are grouped such that potential purchasers may “cooperate” in generating a collective bulk order so that all participants may obtain discount/volume pricing. Once a threshold level or order volume is obtained as a result of multiple orders, the grouped order is submitted to the supplier for fulfillment. The order is then fulfilled at a volume pricing level although individual portions of the collective order are routed to a plurality of purchasers. The system also includes a reverse auction process, which operates to allow potential purchasers to select a product or service and set a maximum price that they are willing to pay for the same. Following submission of this information to the system, possibly including orders for the same item from other potential buyers, potential vendors bid to supply the item to the relevant buyers requesting the item.

Other group purchasing systems create profiles for the purchasers. For example, PCT publication WO 01/01315 A1 to Coleman purportedly describes a method and system utilizing a computer network for aggregating a number of potential purchasers for linking to one or more sellers of goods or services, as well as delivering targeted commercial messages to potential purchasers according to their profiles. A profile is compiled for each purchaser for inclusion in a pool of purchaser profiles in a host computer system. The aggregated purchaser profiles of potential purchasers who have expressed an interest in the seller's goods and services are provided to potential sellers. Advertisers can selectively advertise to those potential purchasers who fit certain profiles that indicate that the potential purchasers may be interested in a specific good or service.

U.S. Pat. No. 6,101,484 to Halbert et al. purportedly describes a dynamic market equilibrium management system that is especially adapted for the sale of goods and services through an online buying group (referred to therein as a “co-op”) formed for the specific purpose of purchasing a particular product by defining a start time, end time, critical mass, any minimum number of units offered, any maximum number of units offered, starting price and product cost curve. As data is gathered from buyers, by means of their making binding purchase offers, the co-op is modified using the market equilibrium manager, so as to take into account market forces such as supply and demand for the item to be sold and their interrelationship with the purchase price for such item. When used with the online buying group, the dynamic market equilibrium management system permits dynamic, real time yield management decisions based on true market data. A graphical user interface receives user inputs for directly manipulating graphical display of data from a database on a display device and displays feedback dependent variable data on the display device, such as in the form of a changed numerical value in response to the user moving at least one data point in the graphical display.

As one can appreciate from the foregoing examples, existing group or aggregate purchasing processes can be quite complex, providing options for the sellers and/or the buyers to define the appropriate market prices of the volume purchases. However, despite the complexity of the existing processes, none provides the flexibility to allow for group purchases that address the different concerns and needs of the individual buyers in the purchasing group. In the group purchasing processes described above, the entire group is limited to purchasing a specific product or service in a “one size fits all” manner. There is neither the option nor the facility online to allow for buyers in a particular purchasing group to maintain their individuality by defining different individual purchasing requirements (such as products, specification, delivery schedule, individual pricing, contract terms, payment terms, audit procedures, etc.) and yet be able to take advantage of the combined buying power of the group purchase. The formation of the purchasing groups does not provide sufficient option for the buyers to maintain control of the group, such as group definition, leadership, norms, values, commitment, buyers and sellers qualification, bidding procedures, timing, etc., factors which represent the buyers to the seller community as a unified and committed buying group, while still allowing each member of the group to uniquely retain their individuality and control pertinent to their purchase.

It is therefore desirable to provide a process that eliminates the goals and practices of standardization of products purchased, contact terms and pricing for all buyers in a group as practiced by the prior art and instead enables all buyers to retain their individual requirements and preferences while purchasing in a group environment.

### SUMMARY OF THE INVENTION

The present invention is directed to a group initiative that allows for flexibility and control in establishing personalized and confidential requirements of the individual members in the group initiative, in the pursuit of their individual self-interest as a member of a group. The individuality of the group members is maintained and the control of the collective bargaining process is retained in the hands of the group. The present invention is particularly suited for collective bargaining based on a group initiative structured over an information exchange network, and more particularly to a method and system for collective bargaining based on a group initiative structure utilizing the Internet.

For the purpose of illustrating the inventive concept, the present invention is described using the example of group initiative for collective bargaining for purchases. The present invention provides the flexibility to establish a purchasing group initiative that addresses the formation and control of the group, and the different concerns and needs of the individual buyers in the purchasing group. A buyer in a particular purchasing group is allowed to maintain their individuality by defining different individual purchasing requirements, such as product or service specification, contract terms, pricing requirements, audit provisions and to achieve at the same time the advantages of the combined buying power of the group. The formation of the purchasing groups provides many options for the buyers to maintain control of the group, such as group definition, membership criteria and invitation, leadership, norms, values, business processes, rules, governance, group management style, buyer commitment, nature of products sought, buyers and sellers qualification criteria, bid/buy game rules, bidding procedures, product sampling process, confidentiality, anonymity, timing, etc., factors which represent the buyers to the seller community as a unified and committed buying group, while still allowing each member of the group to uniquely retain their individuality and control pertinent to purchase. Third party involvement is not required between buyers and sellers, as buyers and sellers negotiate directly on pricing. However, some or all of the buyers and/or sellers may deal indirectly through brokers, agents, and the like if so desired. To compliment the group purchasing initiative, the present invention provides tools that facilitate, for example, formation of the group initiative, and definition of the purchase requirements and pricing requirements for the individual members within the group.

While purchasing groups present themselves to the seller community as a unified and committed buying group, each member uniquely retains their individuality and control. In a specific embodiment, the group has attributes including some or all of the following:

a. Members (buyers) in the same group do not have to buy the same products. They only have to buy products common to all suppliers invited to bid.

b. Members do not know anything about the products other members are buying (other than the categories the group is putting out to bid), what other members currently or historically pay for their products, the savings each member is seeking, and each member's contract terms, delivery or service requirements.

c. All of these aspects of each buyer's purchasing practices remain in the control of each buyer and are not disclosed to one another. No attempt is made to get group members to agree on any of these factors (i.e., the power of group buying without the compromises and conflicts).

d. Each member individually and confidentially sets his own savings goal or “hurdle price”. Sellers must agree to meet or beat this goal in order to obtain the buyers commitment to buy as a member of the group. Members are given one or more opportunities to adjust their hurdle price if they are too aggressive for all sellers; members do not know sellers price during hurdle price adjustment/bidding process, other than the system indicating to the relevant members whether any seller met their hurdle prices. Members whose adjusted hurdle price remains too aggressive for all sellers bidding the group are eliminated from the group.

e. By setting their own savings goal relative to their current prices, members do not compromise any purchasing advantage they may have, or think they have, before joining the group. Members improve relative to themselves. There is no “leveling of the playing field” across the members of a group in terms of prices obtained.

f. Each seller prices each member individually. Even though members may happen to buy exactly the same item, sellers price members individually based on all factors relevant to their pricing decision such as purchase volume, payment terms, product specifications, contract terms, delivery and service requirements, etc. Members do not see the prices quoted to other members.

g. Once each member's hurdle price has been met in earlier rounds of bidding, all members are satisfied and committed to the group. The bid is finally awarded to the seller with the lowest bid for the group overall.

h. Each member determines the acceptability of the prevailing sellers bid after approving the sellers' product quality reliability and service. If a member is not satisfied with all factors beyond price, they do not have to accept the bid.

i. Large organizations can create MGB buying groups made up of buying units internal to their organization in order to create the most practical, advantageous and efficient group buying units at the local, regional and corporate levels.

j. Corporate purchasing executive can establish rules and privileges addressing each of the internal group buying activities on a buying unit or individual buyer level. Doing so enables the corporate buyer to more effectively administer and control buying throughout the organization.

k. Each group maintains control of all aspects of their group buying activities.

l. Buyers can deal directly with suppliers of their choosing. No third party buying service or aggregator needs to be involved with the groups, but such can join as a member of the group representing potentially a buyer or a sub-group of buyers having the same requirements.

m. Suppliers bid simultaneously for each group's business.

### BRIEF DESCRIPTION OF THE DRAWINGS

For a fuller understanding of the nature and advantages of the present invention, as well as the preferred mode of use, reference should be made to the following detailed description read in conjunction with the accompanying drawings. In the following drawings, like reference numerals designate like or similar parts throughout the drawings.

FIG. 1 is an overall diagram of the system.

FIG. 2 is a high-level flow diagram of the group buying process.

FIG. 3A-3B is an overview flow diagram of the group buying process.

FIG. 4 is a flow diagram of the process of forming a new group.

FIG. 5A-5B is a flow diagram of the process of getting new buying members.

FIG. 6A-6B is a flow diagram of the process of getting new sellers.

FIG. 7A-7B is a flow diagram of the process of conducting the bidding game.

FIGS. 8A-8F are tables that show the stages of the bidding process.

FIG. 9 is a diagram of the stages of the group buying process according to the present invention.

### DETAILED DESCRIPTION OF THE PREFERRED EMBODIMENT

The present description is of the best presently contemplated mode of carrying out the invention. This description is made for the purpose of illustrating the general principles of the invention and should not be taken in a limiting sense. The scope of the invention is best determined by reference to the appended claims.

The present invention is directed to a customizable group initiative concept for collective bargaining of individual interests. To facilitate an understanding of the principles and features of the present invention, they are explained with reference to its deployments and implementations in illustrative embodiments. By way of example and not limitation, the present invention is described in reference to examples of deployments and implementations of group initiatives designed for collective bargaining for purchasing products and services in an information exchange environment, and more particularly in the Internet environment. The specific embodiments are directed to purchasing of produce, but purchasing of other products and services can be conducted, such as office products, utilities, maintenance services, fuel, packaging, travel, waste removal, batteries etc.

The present invention can find utility in a variety of implementations without departing from the scope and spirit of the invention, as will be apparent from an understanding of the principles that underlie the invention. It is understood that the customizable group initiative concept of the present invention may be applied for collective bargaining of other natures, whether in an information network environment or otherwise. For example, the customizable group initiative scheme of the present invention may be applied to collective bargaining relating to labor relations, in which workers in a particular profession, industry, department or work detail, for example, may structure a group initiative to negotiate the terms of employment.

As used in the context of the present invention, and generally, “sellers” include any entity that is indirectly or directly presenting a product, service or other offerings (e.g., employment), which may include a direct provider or an intermediary, such as a reseller, broker, and the like. The terms “buyers”, “customers”, “purchaser”, “users” and the like, refer to members of the group initiative, which include any entity seeking offerings from sellers, and may include without limitation, direct end users, or resellers, brokers and buying agents for end users, and the like.

Information Exchange Network

The detailed descriptions that follow are presented largely in terms of methods or processes, symbolic representations of operations, functionalities and features of the invention. These method descriptions and representations are the means used by those skilled in the art to most effectively convey the substance of their work to others skilled in the art. A software implemented method or process is here, and generally, conceived to be a self-consistent sequence of steps leading to a desired result. These steps require physical manipulations of physical quantities. Often, but not necessarily, these quantities take the form of electrical or magnetic signals capable of being stored, transferred, combined, compared, and otherwise manipulated.

Useful devices for performing the software implemented operations of the present invention include, but are not limited to, general or specific purpose digital processing and/or computing devices, which devices may be standalone devices or part of a larger system. The devices may be selectively activated or reconfigured by a program, routine and/or a sequence of instructions and/or logic stored in the devices. In short, use of the methods described and suggested herein is not limited to a particular processing configuration.

The customizable group initiative platform in accordance with the present invention may involve, without limitation, distributed information exchange networks, such as public and private computer networks (e.g., Internet, Intranet, WAN, LAN, etc.), value-added networks, communications networks (e.g., wired or wireless networks), broadcast networks, and a homogeneous or heterogeneous combination of such networks. As will be appreciated by those skilled in the art, the networks include both hardware and software and can be viewed as either, or both, according to which description is most helpful for a particular purpose. For example, the network can be described as a set of hardware nodes that can be interconnected by a communications facility, or alternatively, as the communications facility, or alternatively, as the communications facility itself with or without the nodes. It will be further appreciated that the line between hardware and software is not always sharp, it being understood by those skilled in the art that such networks and communications facility involve both software and hardware aspects.

The Internet is an example of an information exchange network including a computer network in which the present invention may be implemented. Many servers are connected to many clients via Internet network, which comprises a large number of connected information networks that act as a coordinated whole. Various hardware and software components comprising the Internet network include servers, routers, gateways, etc., as they are well known in the art. Further, it is understood that access to the Internet by the servers and clients may be via suitable transmission medium, such as coaxial cable, telephone wire, wireless RF links, or the like. Communication between the servers and the clients takes place by means of an established protocol. As will be noted below, the customizable group initiative system of the present invention may be configured in or as one of the servers, which may be accessed by buyers and seller via clients.

Overall System Design

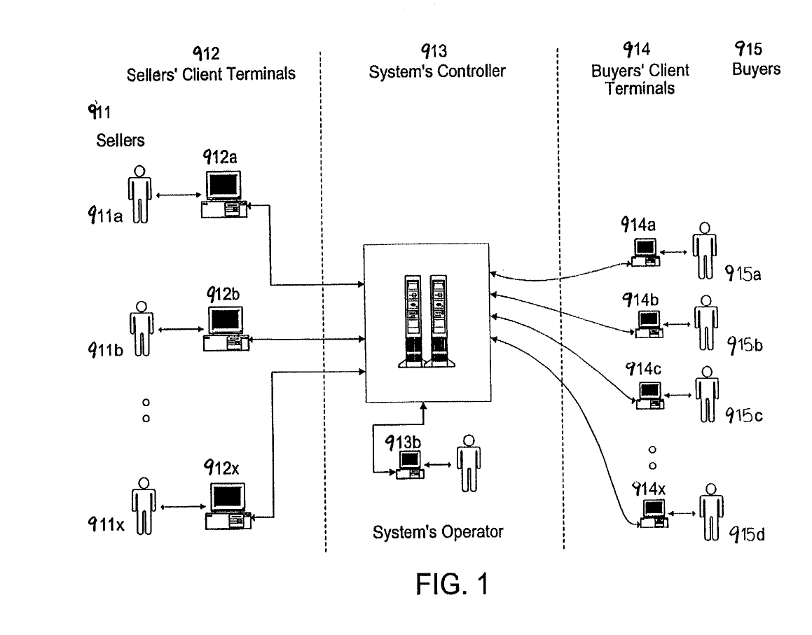

An overall design of the present invention is shown in FIG. 1. In general, the system connects sellers 911 with buyers 915 by means of a system controller 913 maintained at a server in which the functions and features of the customizable group initiative platform in accordance with the present invention is installed. The sellers are designated 911a to 911x and are collectively referred to as sellers 911. The buyers are designated 915a to 915x and are collectively referred to as buyers 915.

The sellers 911 communicate with the controller 913 via client terminals 912 (individually designated 912a to 912x ) and the buyers 915 communicate with the controller 913 via client terminals 914 (individually designated 914a to 914x). Typically but not necessarily communication is via the Internet. As is conventional, client terminals 912 and 914 are connected to an SIP (Internet Service Provider), which provides access to the Internet. Likewise controller 913 is connected to the Internet via an ISP, thus forming an information exchange network in which the group initiative collective bargaining process in accordance with the present invention is conducted. The lines in FIG. 1 therefore represent logical information flow and not physical connections. The sellers 911 and the buyers 914 can be described as being online.

The system controller 913 is one or more conventional network servers running software configured to implement the features and functions of the group initiative process described below, “intelligently” control the appearance of the user interface on one or more physical or “virtual” media (e.g., websites) for access by sellers and buyers, and appropriately monitor and executing the processes and transactions between the buyers and sellers.

The System Operator 913b utilizes a conventional client terminal to access and configure the system's controller 913 as is conventional with computer systems and network servers.

The buyers' client terminals 914 are any of the various conventional terminals that are used to access websites such as computers, laptops, thin-clients, WebTVs, two-way TV, PDAs, information appliances, or any other devices that buyers can use to view or hear offers presented by the sellers via controller 913. Buyers also respond to offers using client terminals 914.

Process Overview

Chart 400 in FIG. 9 schematically shows an overview of the process in which the customizable group initiative in accordance with the present invention may be structured for group purchasing, including group formation, goals and operating procedures, creation of product or service specifications, establishing savings goals, RFQ preparation and posting, bidding and fulfillment stages. Generally, at the group formation stage, buyers come together electronically to form a group, establish how the group will operate and invite and qualify sellers that choose to participate at block 1. Buyers may also enter product and service specifications (including their savings goals depicted as hurdle prices that must be achieved to sellers to be discussed in greater details below) at this stage.

At the RFQ stage in block 2, the RFQ specifications for the purchases are determined. This may involve the steps of (a) the buyers entering their product and service specifications and savings goals, (b) the sellers asking questions about the RFQ specifications, (c) the buyers answering questions and editing RFQ specifications if needed, and (d) buyers and sellers approving and confirming RFQ specifications.

Buyers do not have to buy the same products, only products within the same category of products such as office supplies. At the bidding stage, sellers review each buyers' specifications and hurdle prices and confidentially posts first round bids for each buyer individually at block 3. The system checks for price errors and buyers and sellers reconfirm their prices. Sellers do not have to quote all buyers the same price.

Buyers whose savings goals are not met or bettered by any of the sellers first round bids are given two chances in block 4 and block 5 to lower their expectations or savings goal if they so choose in order to stay in the group. If that goal is not met after two revisions the buyer opts out or is eliminated from the group. Buyers are not made aware of sellers' bids, they simply are establishing a savings goal that makes it worthwhile for them to purchase as a member of the group. In this manner, sellers may garner a buyers business at a higher price than they posted in round one.

Once all buyers have either raised their hurdle prices to a level that is met by at least one of the sellers or if not, exited from the game, sellers are then given notice that they have the opportunity to meet buyers hurdle prices they may not have met with their round one bids. They must meet all buyers hurdle prices at this stage (since at least one seller has) or exit the game (Block 6).

Sellers agreeing to meet all remaining buyers hurdle prices are then asked to make their best and final bids for each buyer individually in block 7. At the fulfillment stage, the seller with the lowest bid for the group overall is conditionally awarded the contract based on the RFQ at block 8. Buyers and the conditionally winning seller exchange further information at this stage in order to make the final approval of each other and having done so, the process moves forward to final contract award at block 9.

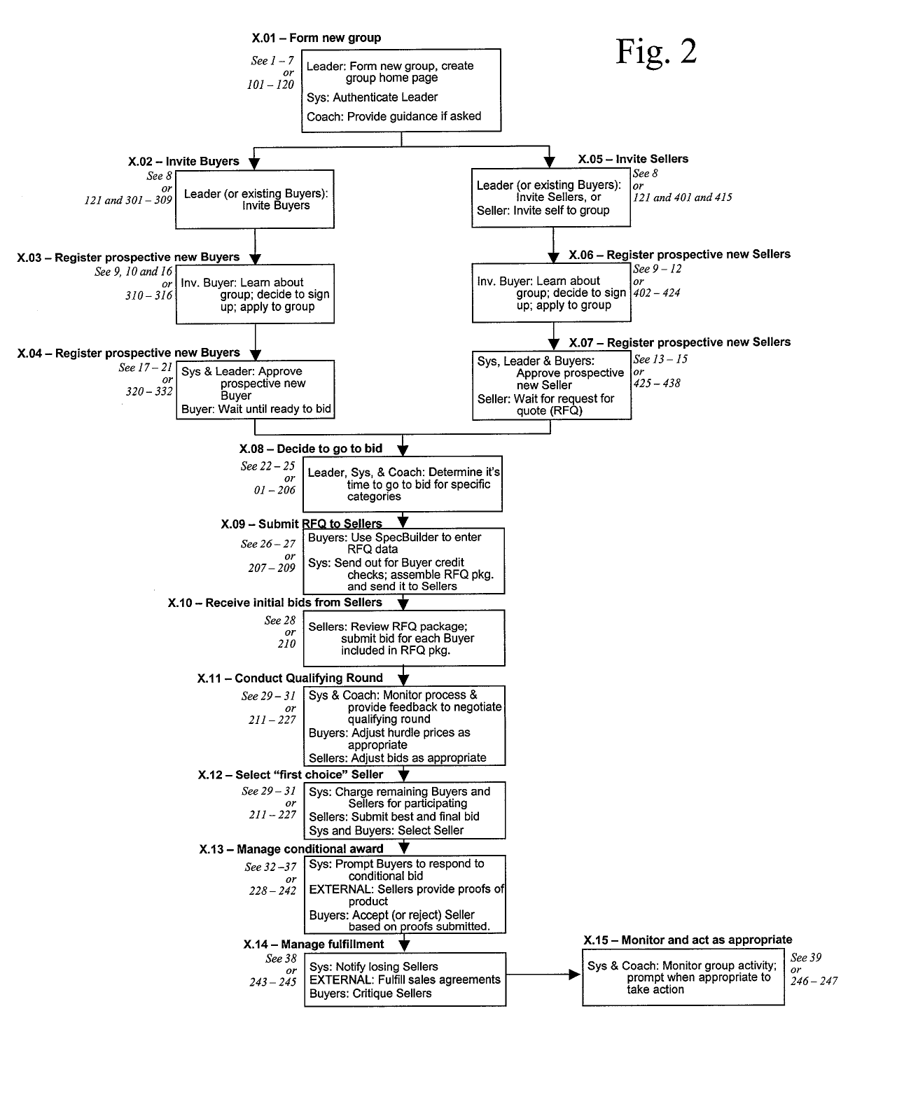

FIG. 2 shows a flow chart of the high-level process according to the present invention. In forming a new group (x.01), after a leader (a buyer) is authenticated, he begins inviting buyers (x.02 ). The newly invited prospective buyers can learn about and apply to the group. After approval by the leader (and processed by the system 913), the new buyer is registered (x.02-x.04). The leader also begins to invite sellers (x.05); sellers can also invite themselves to the existing group. The invited sellers learn about the group, and can decide to join and apply (x.06). Similarly, after approval by the leader (and processed by the system 913), in addition to the buyers, the new seller is registered (x.07). In preparation for the bidding process, buyers use SpecBuilder to describe what they want to buy along with their quantities and savings goal, which information is assembled into an RFQ and posted for the sellers. The system 913 receives initial bids from sellers (x.10). After conducting a Qualifying Round, the system 913 elicits best and final bids and selects the “first choice” seller or the initial conditional winner. The final stages include managing conditional award and fulfillment (x.14-x.15).

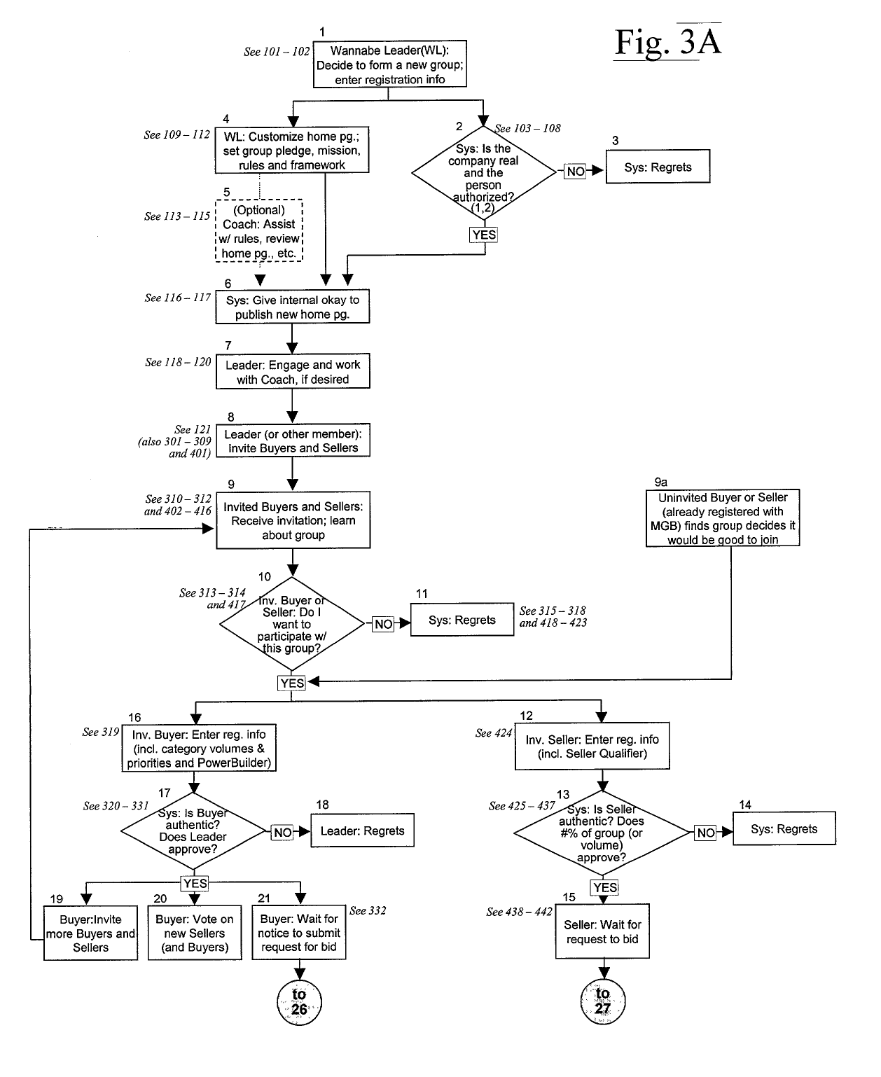

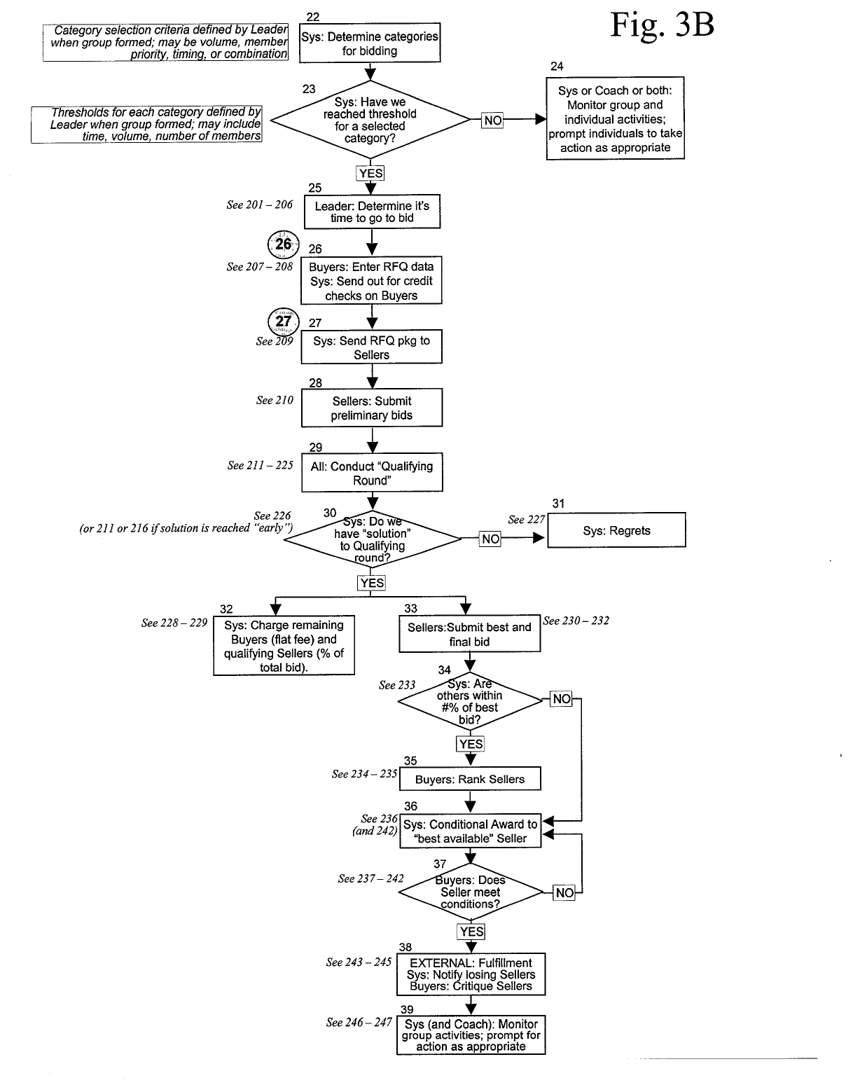

FIGS. 3A and 3B show an overview of the process according to the present invention. The Forming steps are 1-8. Getting new sellers and buyers is described in steps 10-21 (sellers: 12-15, buyers: 16-21). Steps 25-39 show the bidding process. The process will be described in greater detail below.

Forming A New Group

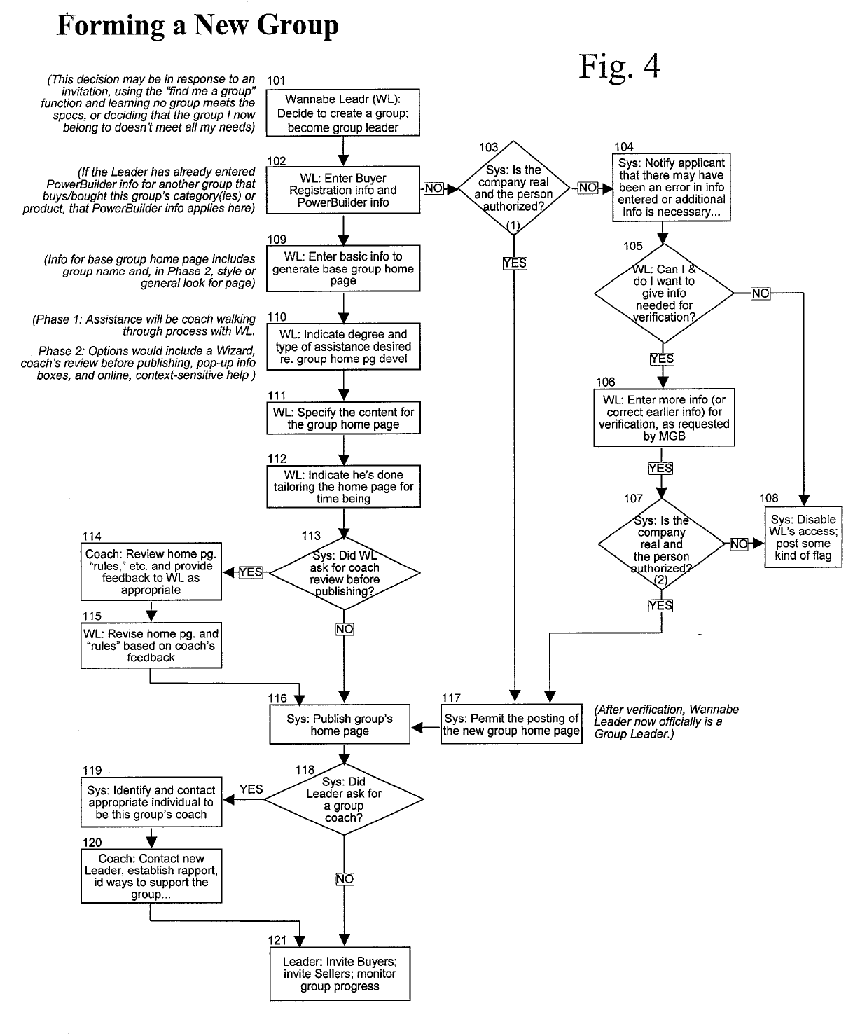

In FIG. 4, an individual decides to form a new group, thus becoming the group leader (101-102). The leader enters Buyer Registration Information and PowerBuilder information. Buyer Registration Info can include contact information, the industry the buyer is in, product and service category the group will address of interest, and other relevant information about the buyer. PowerBuilder is a way of setting parameters to define the attributes of the group and the commonality of members, and to score buyers who are interested in joining a buying group. The buyers answer a number of multiple-choice questions; each selection is assigned a predetermined number of points, with the greatest number of points being awarded for contributions that increase the attractiveness of the buyer to sellers. Some examples of information elicited through PowerBuilder include payment terms (e.g. net 30), monthly purchasing volume (e.g. $15,000), number of deliveries per week, and the delivery time window (e.g. before 11 AM). After all the questions are answered, the system calculates the total (out of 100) that is now associated with the particular buyer. Group leaders may set minimum PowerBuilder scores that must be achieved to be accepted to the group.

One of the advantages of PowerBuilder from sellers' perspective is that buyers are presented in a group on a platform in a “ready to buy” frame of mind. The sellers can identify desirable buyers by evaluating the same information about buyers the PowerBuilder collects and presents. With this information, sellers can determine the attractiveness and power found in a group of buyers, regardless of the products or services they are purchasing.

After the buyer enters the above information, the system 913 maybe configured to authenticate the company and the person creating the group (103), after which the new group home page is granted permission to be posted (117). If the system finds that the company is not real and that the person is not authorized, additional/corrected information can be entered to allow authorization (104-107). The system may be configured to disable access to the person (108).

The leader enters basic information to generate a base group home page, for example information concerning product category to be purchased, length of contract, leader's goals for number of buyers and sellers he wants to attract to the group, bidding instructions, type of bidding process to be employed, qualification criteria for buyers and sellers, group calendar of events (109). The group leader indicates the degree and type of assistance desired from the system 913 regarding the group home page development (110). An optional coach associated with the system 913 can assist the leader with the home page, rules, and other advice (112-115), before publishing the group's home page (116).

The group home page can contain info such as: group name, pledges, missions, product category, pricing plan, contract length, RFQ thresholds (target volume, number of buyers, number of sellers, time; to be discussed below), minimum number of sellers to achieve a solution, bidding instruction, conditional award period, final award threshold, and PowerBuilder range.

The coach may have an ongoing role after initial group setup. The group leader has the option of assistance by a coach (118-120) before and after the group leader invites buyers and sellers (121). The leader can choose from at least two forms of assistance from the coach who walks through the process with him: (a) administrative assistance that helps move the group along (e.g., reminding members they have a task to complete by a certain time); (b) guidance from the coach as a product category specialist; a purchasing professional that lends their expertise to a group such as additional sources of supply, new products or suggestions on specifications.

The coach is preferably a live person (e.g., system operator 913b in FIG. 1), which is available upon request to guide the group leader through the bidding process within an industry that the coach is very experienced. Buyers are often required to purchase products that are very complex and about which they know very little. The value of a live coach's experienced in the area is invaluable, as it blends technology and human interaction to facilitate the intended transactions. It is contemplated that a virtual coach programmed in the system controller 13 may also be deployed with the necessary intelligence (i.e., artificial intelligence) to assist the group leaders.

Getting New Buying Member

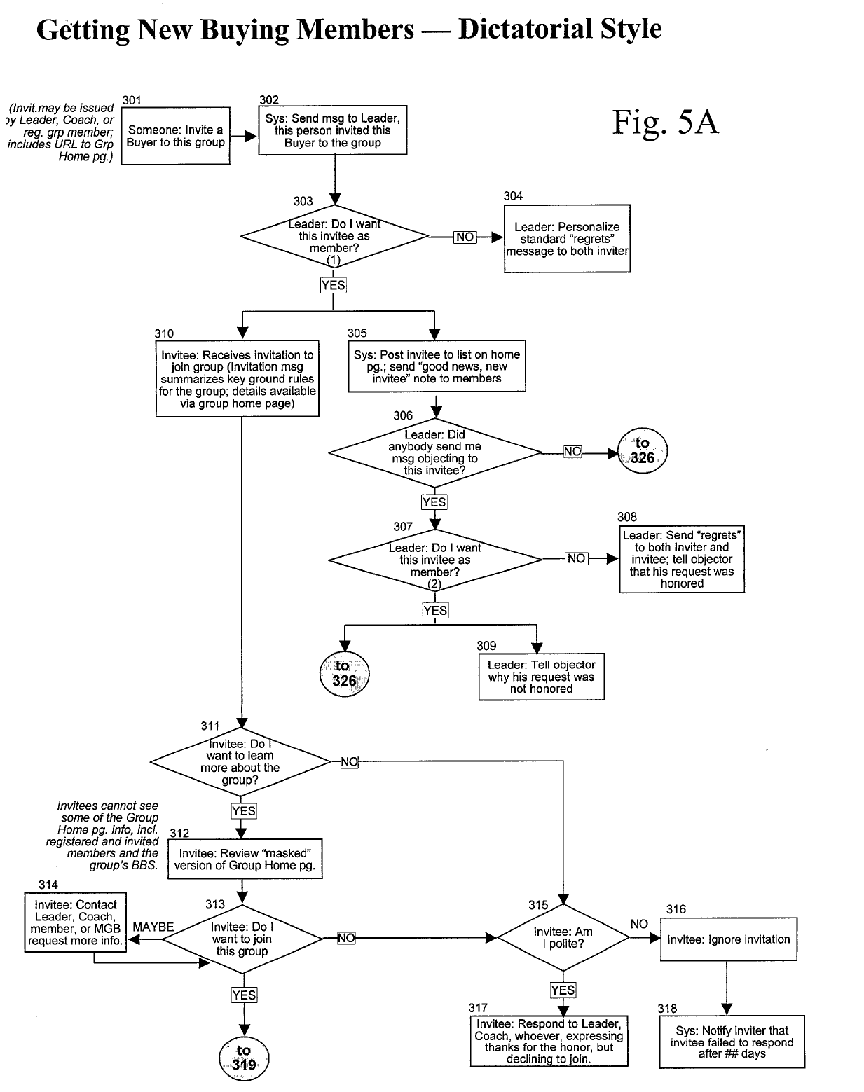

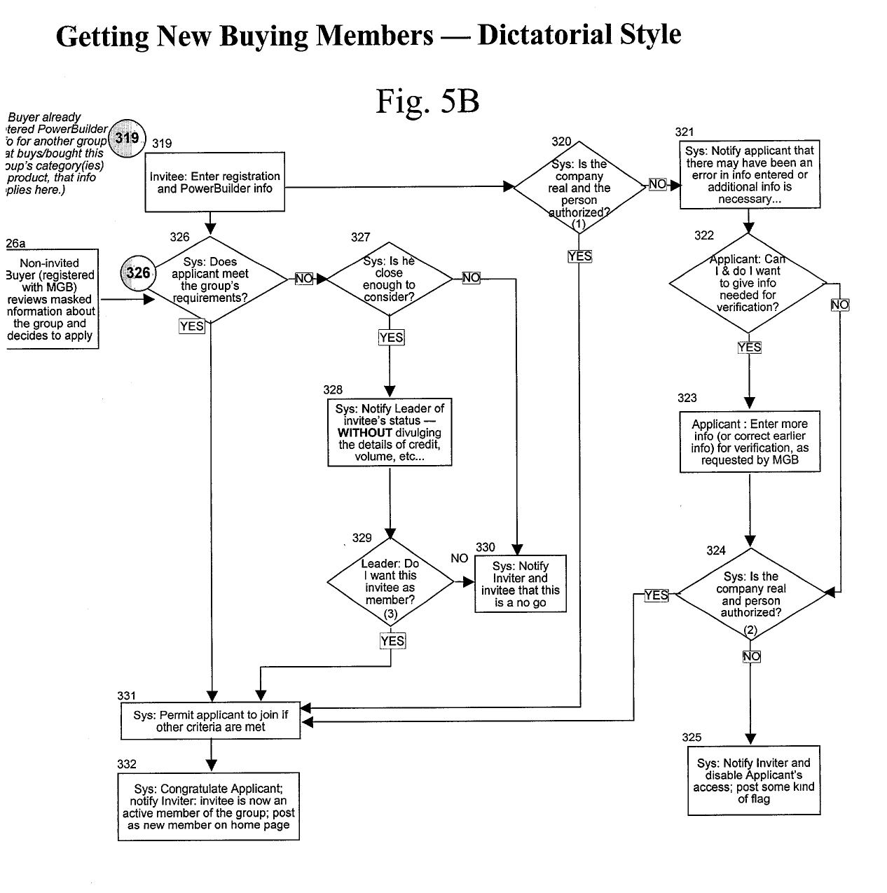

In FIGS. 5A and 5B, one possible method of getting new buying members is described (the “dictatorial” style). Invitations are issued by the leader, coach, or regular group member so that the invitee can access the group home page (301). The leader is given the option to deny membership of the invitee (303-304).

If the leader wants the invitee as a member, the system posts the acceptance of the invitee and notifies the other members (305). If there are no objection messages to this invitee, then the process continues (step 326, to be discussed below). If there are objections, the leader has the final say (308, 309).

The invitee receives the invitation message with relevant information (e.g., ground rules) (310). To learn more about the group, the invitee reviews a “masked” version of the group home page without information about registered and invited members, plus the group's bulletin board (312). The invitee can choose to join the group after requesting more information (313, 314). The invitee can also choose to decline joining the group (315-318).

After the invitee decides to join the group, she enters registration and PowerBuilder info. The system 913 maybe configured to verify if the company is real and if the person is authorized as a set of criteria (320). After verification, the applicant can join if all other criteria are met (321). If the system finds that the company is not real and that the person is not authorized, additional/corrected information must be entered to allow authorization (321-324); otherwise, the system disables access to the person (325). Another set of criteria includes having the applicant meet the group's requirements (326). The leader is given notification of the status of the invitee, and given the choice to allow invitee to join or not (327-330).

The system congratulates the new member and notifies the other members of the group (332).

Getting New Sellers

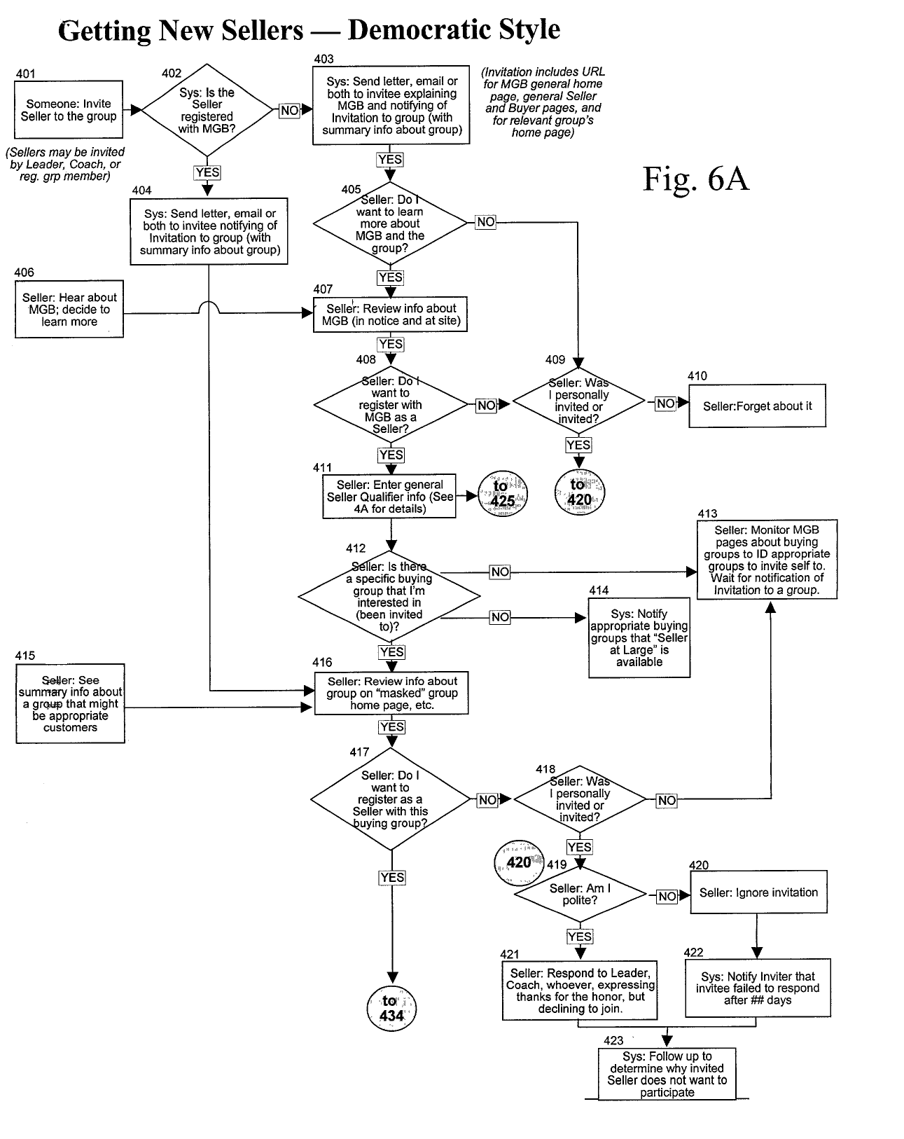

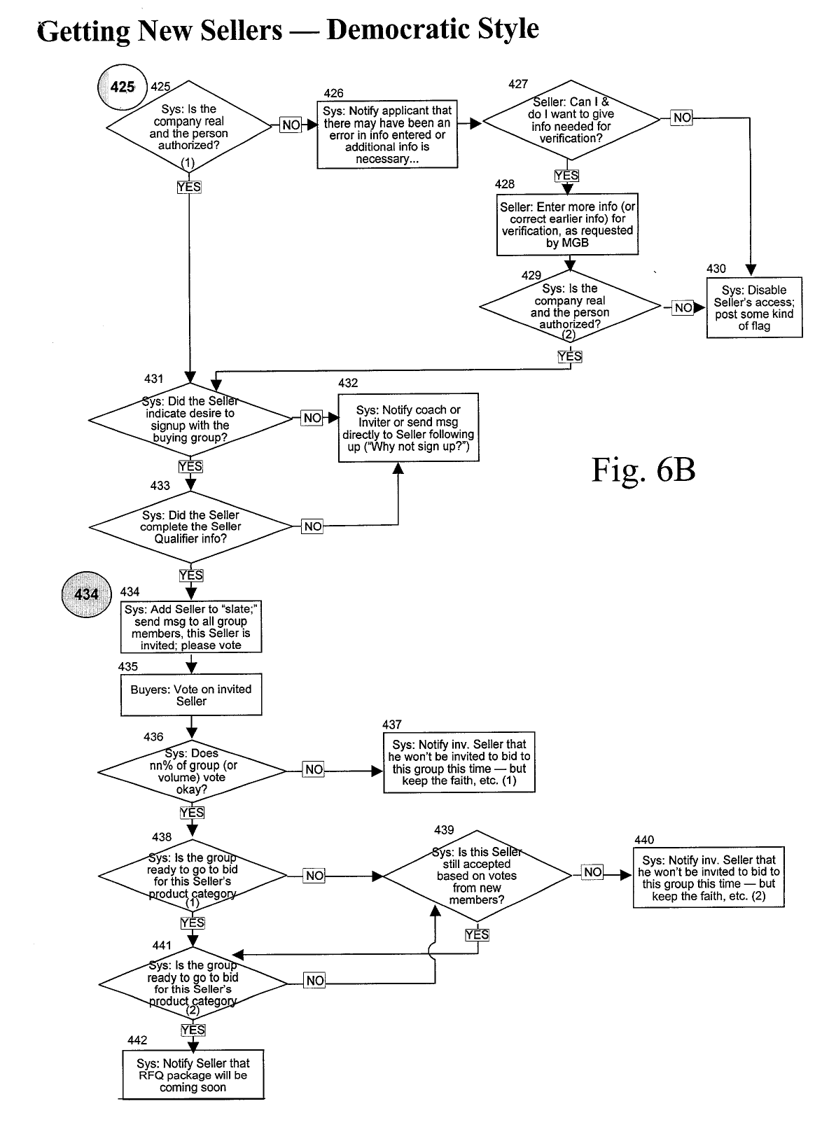

In FIGS. 6A and 6B, one possible method of getting new sellers is described (the “democratic” style). Although the process of getting new buyers has been described as “dictatorial” and that of getting new sellers as “democratic,” the present invention is not limited to these styles. Further, the other parts of the group initiative process can optionally be conducted by either of these styles, not limited to the sub-process of getting buyers or sellers.

Invitations are issued by the leader, coach, or regular group member (401). The next set of steps consists of the invited seller learning about the group (402-416). If the seller is not registered, he is given an opportunity to learn about the group (403) before entering his Seller Qualifier Info (411). Seller Qualifier Info can include any number of features that enable buyers to evaluate the qualifications of the seller including factors such as how long in business, service and reliability metrics, customer service capabilities, insurance carried, annual sales volume, delivery time window, level of product liability insurance, number of inventory line items, etc. Alternatively or in addition, a weight system can be established by the group leader and/or the members may together assign values to sellers' qualifications and/or elements of the sellers' bids including factors such as price, product availability, quality, timing, incumbency, etc., so that the sellers may be qualified based on emphasis placed on the products and services most important to the group. Options for the next step are to have the seller monitor email notification from the group leader as to whether the seller has been accepted to the group. Alternatively, seller can apply to groups that interest them and wait for acceptance, e.g. registering with group pages and wait for an invitation (413) or to have the system notify buying groups that a seller is available (414). Alternatively, the seller can find a specific buying group (perhaps already invited to one) so that he can review information about the group on a “masked” group home page (416).

The seller then decides whether or not he should register with the particular group (417). If not, the seller declines to join the group by giving notification or by failing to respond after a set time period (315-318). If the seller wants to register (FIG. 6B), the system checks for authentication (425), as explained in the previous embodiments. If the system finds that the company is not real and that the person is not authorized, additional/corrected information must be entered to allow authorization (426-429); otherwise, the system disables access to the person (430). After meeting the above conditions, the system checks to see if the seller wanted to sign up with the buying group (431). If not, the system notifies the coach, inviter, or seller to follow up. If the seller wants to sign up, the system checks if the Seller Qualifier Info has been completed (433). Then, a voting process begins by the buyers (434, 435-437). If a certain percentage of the buying group approves (436), the system waits to see if the group is ready to go to bid (438-441). Alternatively, the group leader instructs buyers to input RFQ when other thresholds have been met. When the group is ready, the system notifies the seller that the RFQ package will be coming soon.

Going back to FIG. 3B, the system 913 implements the parameters for bidding (e.g., volume, member priority, timing), which have been defined by the leader when the group was formed (22). The system checks to see if a threshold (e.g., time, volume, number of members) has been reached for a selected category (23). These thresholds have also been defined by the leader at the time of group forming.

Conducting The “Bidding Game”

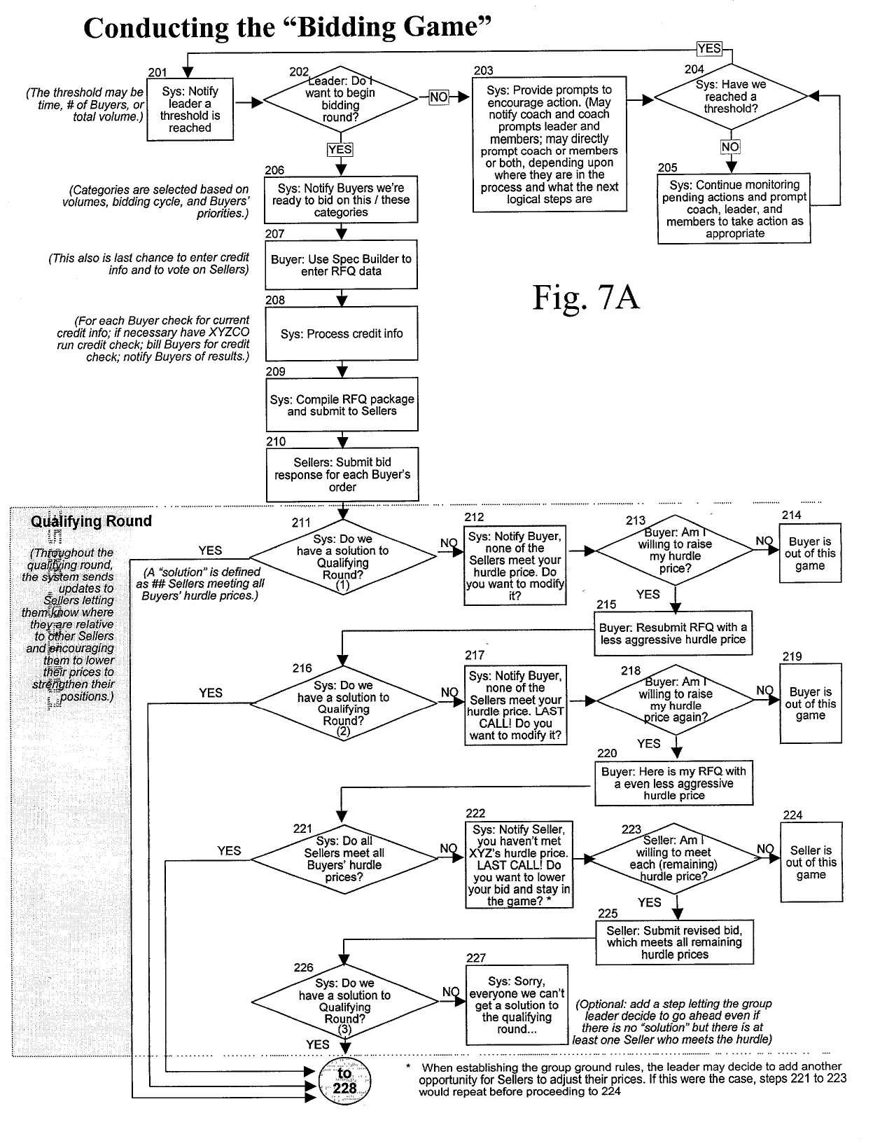

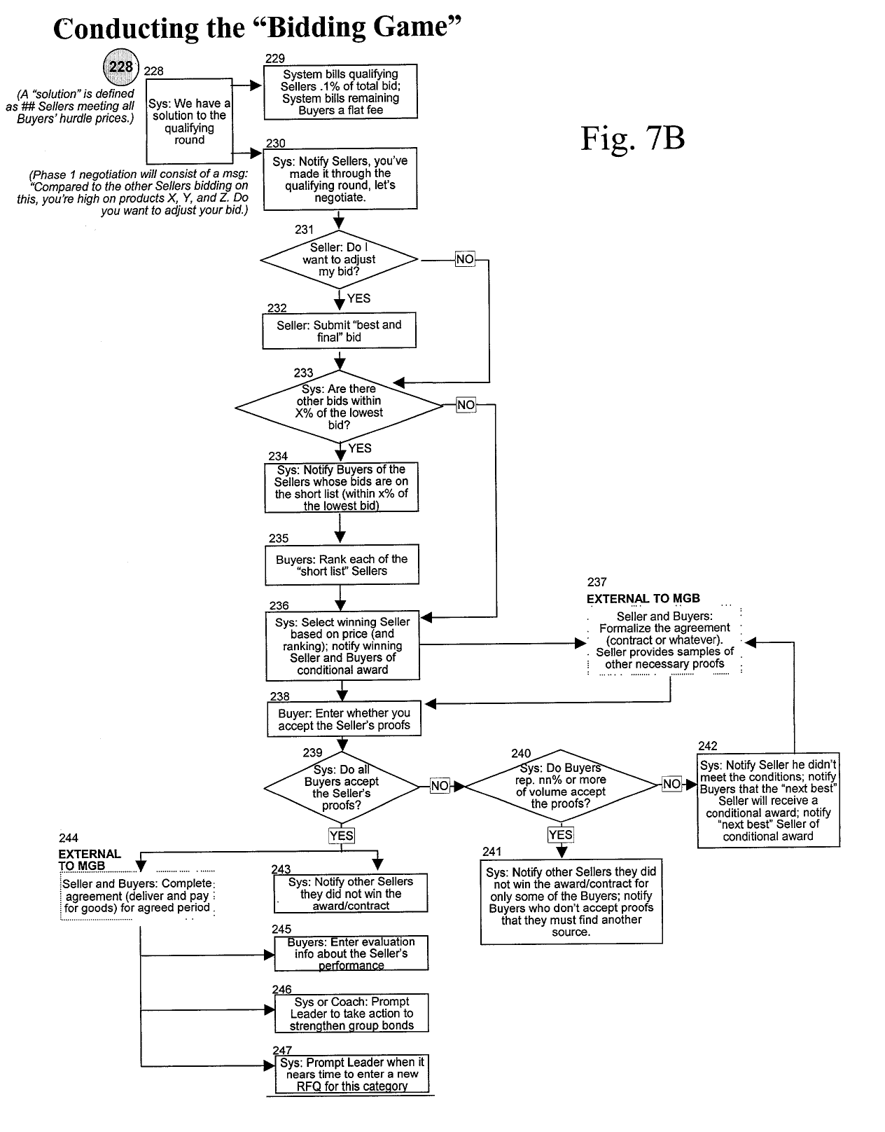

FIGS. 7A and 7B detail the process of bidding. The system notifies the leader that a threshold has been reached (201). During the first part of the process, the leader determines when the bidding round is to start (202). A group calendar may be established which the leader uses to establish time allowed for each step in the process. If the leader does not want to begin, the system provides prompts to the leader (and/or coach, members) to encourage action (203). The system can monitor pending actions and prompt members to take action (205) if a threshold has not been reached (204).

SpecBuilder, RFO, and Hurdle Price

If the leader wants to begin, the system notifies buyers that it is time to bid (206). The buyer uses SpecBuilder (a function of the system 913, e.g., offered via a web page) to enter RFQ data (207); this is the last chance to enter credit info and to vote on sellers. The SpecBuilder offers a simple, very concise method of collecting and documenting the exact specifications of products used by the buyer and transmits that information to the seller as an RFQ in a useable and time sensitive format. The SpecBuilder converts buyers' and sellers' differing descriptions of products into a common form and language understood by all buyers and sellers.

Through information provided on SpecBuilder, individual, less experience buyers would be capable to effectively take part in a group initiative, as described above. The system 913 may also be configured to match the buyer to sellers who offer the same product based on the buyer specification. The SpecBuilder can function as a shopping service for a buyer looking for alternate sources.

The format used by SpecBuilder may follow the standards, conventions, identifications and/or characteristics associated with particular industry groups, associations or the like. For example, in the food service industry, the format of the SpecBuilder approximates the standards used by the United Stated Department of Agriculture (USDA) to formulate product specifications. (e.g., the characteristics used by the USDA to distinguish one apple either within the same variety or across different varieties from one another are the same characteristics used by SpecBuilder, such as size, variety, grade, pack size, growing origin, color, etc.) Products that do not have pre-existing standards of identification (such as the USDA), like paper, equipment and uniforms will be formatted by SpecBuilder in an equally universal language and format. The goal is to arrive at a description (specification) of a product that is clear, concise and indisputable no matter who is using it. This removes the guesswork required of sellers presently and their job becomes significantly easier. Errors in pricing and misunderstandings are greatly reduced. Once spec is known, users can access historical data to see what happens seasonally as a rule. The SpecBuilder may also include or associate with services that forecast future trends. SpecBuilder may provide a forward-looking feature that allows the buyer to know how pricing may change for a particular product in the coming months (e.g., according to USDA).

The SpecBuilder allows the system to create a Request For Quote (RFQ) datasheet that includes a list of information such as the product name, product description, current base price, target price, quantity, total, and notes/comments, as well as the hurdle price. According to an aspect of the present invention, the buyers in the same group do not have to buy the same products, only products within the same category of products. For example, for office equipment as product category, one buyer may place RFQ for printers and another buyer enters RFQ for fax machines. Sellers carry entire range of products with the particular product category and can bid on printers and fax machines. The products offered for bid by participating sellers must be common to all sellers who are invited to bid. For example, buyers may buy personal computers, printers, fax machines, accessories, etc., in the same bid as long as all sellers cover this array of products, and the buyers buying fax machines do not have to buy the same fax machines.

According to another aspect of the present invention, throughout the bidding process, a buyer does not know information entered for the RFQ about specific products that another buyer is buying, except the product category. The method of the present invention allows buyers to keep information confidential, and to buy exactly what they want to buy on their own terms instead of a one size fits all solution, while still enjoying the cost benefits of group buying.

At the RFQ round, Buyers and sellers could exchange questions and answers relative to the specifications posted by buyers. Sellers are asked to review the buyers' specifications and post any questions they have about the nature of the product required by the buyer. All questions asked by sellers are posted for all sellers to see. All responding answers from buyers are posted for all sellers to see. At the close of this round, all buyers are asked to modify their official RFQ to correspond with the information shared through the question/answer portion.

For example:

A buyer posted an RFQ for “Fittings-PVC-Fittings Angled”. They include in the specification the diameter, degree of angle, threading and purchase unit. The buyer forgets to include (or may never have been asked to include) the schedule (psi) or color (white is for potable water, lavender is for irrigation only). When asked to review the original specs, sellers are able to post their questions relative to the missing information. The inclusion of this information insures that all sellers will be pricing the same product that is crucial to the accuracy of the bid analysis later and because the questions and the answers are shared with all sellers, all sellers are able to work from the same information base.

In this example, the buyer is asked in the final stage of the clarification round to officially edit their specification for “Fittings-PVC- Fittings Angled” to include a Schedule of 100 psi and a color of Lavender. Without this exchange of information, sellers are left guessing about critical aspects of the specification, which in turn has a tremendous impact on the price that they will ultimately quote.

Sellers are not limited to only clarification questions. They can ask buyers any question such as “would you accept a different pack size or an alternate product?”.

The Hurdle Price is the most a buyer is willing to pay for a product in the case of a single item RFQ or a group of products. The difference between the established hurdle price and a base price established on any pricing basis the buyers choose (such as last price paid, a historical average price, current contract pricing, or competitive pricing) can be established as a savings goal by the buyer. A buyer confidentially sets his own Hurdle Price by entering the amount he currently pays or base price of his choosing for the products he is including in his RFQ, and then determining how much he must save in order to proceed with the purchase through this buying group (the target savings can be a percentage savings or dollar savings). Buyer does not need to disclose to others the difference is his base price (however that is established) and his savings goal. For example, if a buyer wants to buy 100 widgets, 250 doohaas, and 500 larpings (see Table 1 below), this order would cost him $2,000 at the price he is currently paying his supplier. He decides that he must save at least 10% ($200) before he would switch to a new supplier, purchasing through the buying group of the present invention. His hurdle price for this order would be $1,800. Any seller who wants to get this buyer's order through the online system must offer to sell him 100 widgets, 250 doohaas, and 500 larpings for $1,800 or less.

TABLE 1
Hurdle Price

| Target Savings: $200 10% | | | |
|---|---|---|---|
| | Current Price | | Current |
| Product | per Item | Quantity | Cost |
| Widget | $5.00 | 100 | $500.00 |
| Doohaas | 2.00 | 250 | 500.00 |
| Larpings | 2.00 | 500 | 1000.00 |

| | |
|---|---|
| Current Total Cost for this order | $2,000.00 |
| Less target savings | −200.00 |
| Hurdle price for this order | $1,800.00 |

If a buyer's hurdle price is seen as unreasonable by the sellers bidding the group, the sellers can decline to bid or may enter a bid that is higher than the buyer's hurdle price. If no sellers meet a buyer's Hurdle Price, the buyer may be given at least one chance to increase his hurdle price. If at least one seller accepts the Hurdle Price of a buyer, the system then considers the Hurdle price to be reasonable. In one embodiment, the buyer is given two chances to raise his hurdle price if he so chooses. If he does not want to raise his hurdle, he thereby elects to exit from the game. If he is essentially negotiating, meaning his initial hurdle price was more aggressive than he really needs, he can then adjust his hurdle upward to see if he can still save an amount that makes it worth his while to participate in the group. During the hurdle price adjustment process, the buyer is not privy to the sellers' initial bids. This information is not disclosed so that sellers may be able to satisfy a buyer's hurdle without posting their best price, thereby saving margin for themselves while they satisfy the buyer at the same time. This process will be described in further detail below.

The system processes credit information (208), after which it compiles the RFQ package and submits it to the sellers (209). Sellers submit bid responses for each buyer's order using a bid submission form (210). The bid submission form documents information provided by the seller. The seller is able to see information about the buyer such as the individual buyer's masked ID, payment promise (e.g., net 30), credit rating, volume, samples/proof requirements, and any other information customized by the group for this group buying process. There is also provided the relevant Group PowerBuilder information, which will include the duration of the contract (the bid cycle) and any other information appropriate to this buying group. The information on the bid submission form is similar to that of the RFQ provided by the buyer. The specifications listed by the buyer are listed; the seller enters his prices for each product. After the seller has completed the bid submission form, the price for the total order is compared to the buyer's hurdle price, which is set for his overall RFQ, not on each individual item with his RFQ. While the individual item prices are important, the system only evaluates aggregate price and compares to aggregate hurdle to establish a solution or awarding a sale. Buyers is less concern about the cost of any individual item as long as overall they are saving the desired amount

Throughout the rounds of bidding, the sellers price each buyer individually. Even though buyers may happen to buy exactly the same item, sellers price members individually based on factors relevant to their pricing decision, such as purchase volume, payment terms, product specifications, contract terms, delivery and service requirements, etc. Buyers do not see the prices quoted to other buyers.

Qualifying Round

The Qualifying Round is conducted next, as shown in steps 211-225. In this round, the system queries and determines if the sellers' bids are able to meet the buyers' hurdle prices. Referring to FIG. 7A, when the process enters the Qualifying Round at 211, the number of sellers meeting all the buyers' hurdle prices is determined, and if said number met the threshold number of sellers (as previously defined by the group leader when the group was formed) which must meet all the buyers' hurdle price, there is a solution of the Qualifying Round and the process proceeds to step 228. If the number of sellers meeting all buyers' hurdle price is less than the threshold number, the group proceeds to step 212, where the system notifies each buyer that an inadequate number of sellers met the buyer's hurdle price. Each buyer is given the opportunity to modify it. By choosing not to raise his hurdle price (213), the buyer is out of this game. On the other hand, if the buyer is willing, he resubmits his RFQ with a less aggressive hurdle price (215).

After buyers modified (i.e., raised) their hurdle price, the system checks a second time to see if there is a solution to the Qualifying Round (216). If not, the buyer is notified that an inadequate number sellers met his revised hurdle price and that he must modify it again (217). If in this second stage the buyer is unwilling to raise his hurdle price (218), then the buyer is out of this game (219). The buyer that modifies his hurdle price submits a RFQ with an even less aggressive hurdle price (220) than in step 215.

Now the Qualifying Round shifts from the buyer to the seller. In step 221, the system checks if all sellers meet all buyers' hurdle prices. If they do, the group proceeds to step 228. If they do not, the system notifies each seller that has not met all buyers hurdle prices (222). If the seller chooses not to meet each hurdle price for each of the buyers in the group, he is out of this game (224). If he chooses to meet it, the seller then submits revised bids that meet or better all remaining hurdle prices (225). As shown in the flow chart, the system checks again if there is a solution to the Qualifying Round (226). Once a solution has been achieved, the group moves out of the Qualifying Round into step 228. However, if there is no solution to the Qualifying Round (finally determined at 226), the bidding process exits or continues under limited conditions described below.

The process may be configured such that even without a solution, the group leader may elect to proceed if the number of sellers he initially wanted in the game at this stage is less than he expected. In accordance with the embodiment of the bidding game described here, the group leader may be given an opportunity to still decide to proceed when there is at least one seller who meets the hurdle prices of all buyers, but he cannot proceed if no seller meets all buyer hurdle prices, in which case the game is over; i.e., the system shows that there was no solution (227). The Qualifying Round has now ended.

If there is a solution or if the group leader decides to proceed as permitted in accordance with the particular bidding game logic, the group proceeds to step 228, as seen in FIG. 7B.

The system informs sellers of each buyer's aggregate hurdle price for all items in his RFQ. Sellers do not know anything about other sellers' pricing except at the step in block 6 (FIG. 9) when they are told that at least one other seller has met each remaining buyers' hurdle price.

No details other than that fact are disclosed. Seller then decides if he wants to meet buyer hurdles not yet met or exit the game. (Alternatively, the system may be configured to send updates to sellers to let them know where they are relative to other sellers.)

Proceeding with the Bidding Process

Continuing the bidding process, the system may be configured to charge the remaining buyers and qualifying sellers a fee, e.g., a flat fee for the buyers and a percentage of the total bid for the qualifying sellers (229). Depending on the system configuration, charges may be assessed buyers and sellers at this point or prior to or after the group process, and charges may be waived against the buyers and/or sellers completely. The system notifies sellers that they have made it through the Qualifying Round (230), so the sellers are given an opportunity to adjust their “best and final” bids (231, 232). At this stage in the process, all members are committed to purchase through the group since their hurdle prices have been met. The bid is awarded on a conditional basis to the seller with the lowest bid for the group overall.

As a further variation of the process, the system 913 may check to see if there are any other bids within a certain percentage of the lowest bid (233). If there are, the system notifies buyers of those sellers (234), who are ranked by buyers (235). The buyers select the winning seller based on low bids and ranking; the remaining group is notified of the results (236). The bid is conditionally awarded to such seller.

After conditional award of the award, external to the online bidding game, the seller and buyers formalize the agreement after plant tours, credit checks, sample evaluation, and other relevant tasks necessary for the buyers and sellers to determine final acceptability of all parties (237). If all the buyers do not accept the seller's proofs (238, 239), the system checks if there is an acceptable percentage of buyers who do accept the proofs as established by the group leader when setting up the group (240). If at this time, there is not a sufficient percentage for approval, the system notifies that seller that conditions were not met; the next best seller will receive notification of the conditional award (242), returning back to step 237.

If all the buyers do accept the seller's proofs (at step 243), the system notifies next lowest bidder only and conditional award process begins again. It is noted that buyers only see winning bid of lowest seller, but they do not see bids from other sellers. This is because if they did, they might see that another sellers actually had a lower price for them but did not win because their bid was not lowest for group overall. Such info would splinter the group. Buyers accept this “blackout” since their hurdle price is met so they are satisfied with the award knowing that theoretically another seller could have had lower price for them individually.

External to the online bidding process, the winning seller and buyers complete their agreement of delivering and paying for goods (244). Buyers are given the opportunity to enter evaluations about the seller's performance (245), the system or coach prompts the leader to take action to strengthen group bonds (246), and the system prompts the leader when it is time to enter a new RFQ for the category (247).

### Example

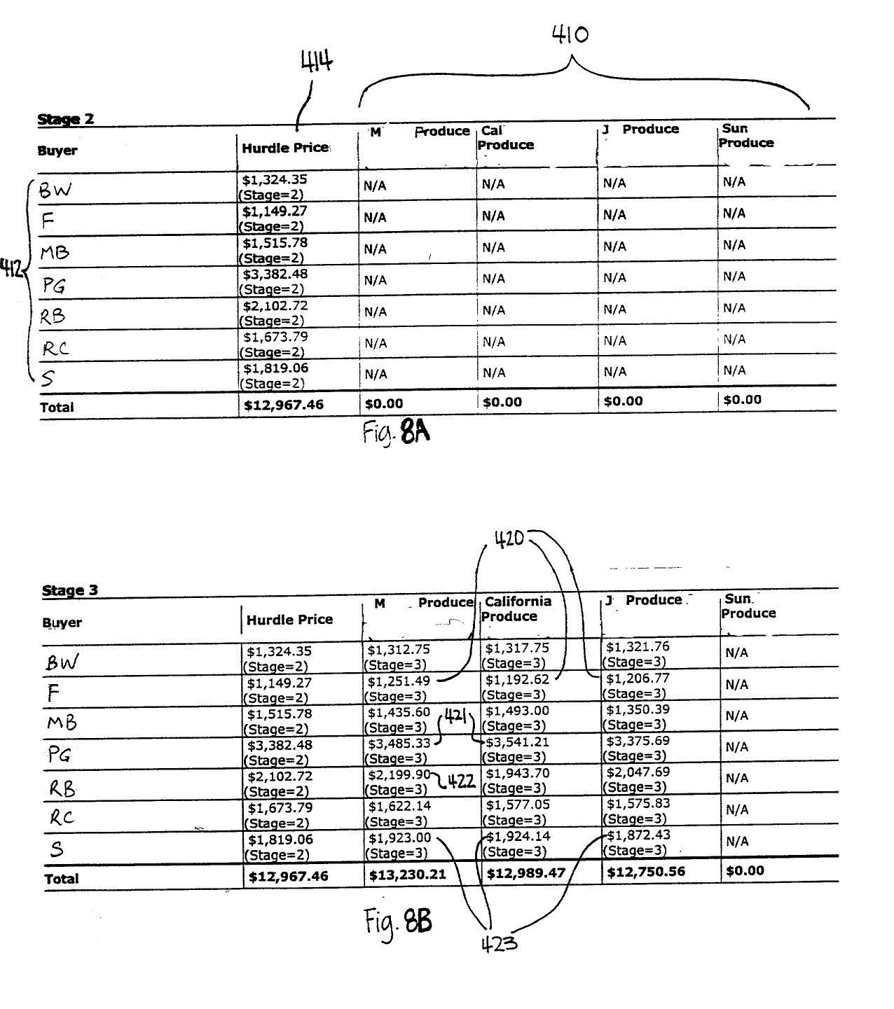

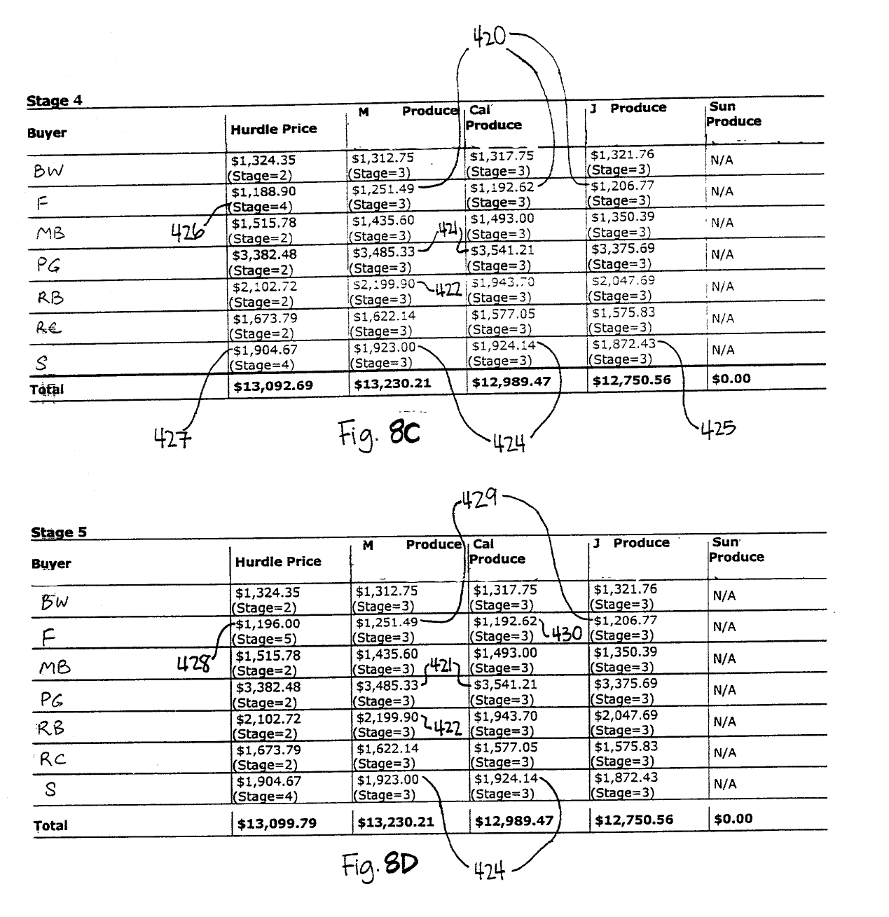

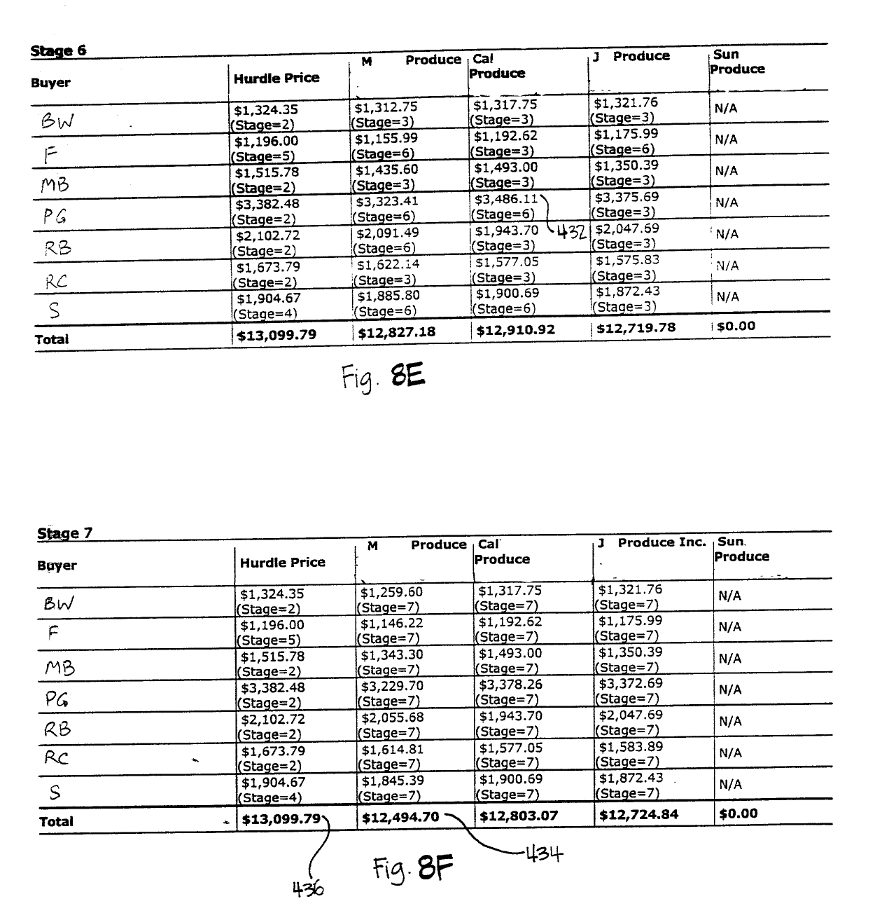

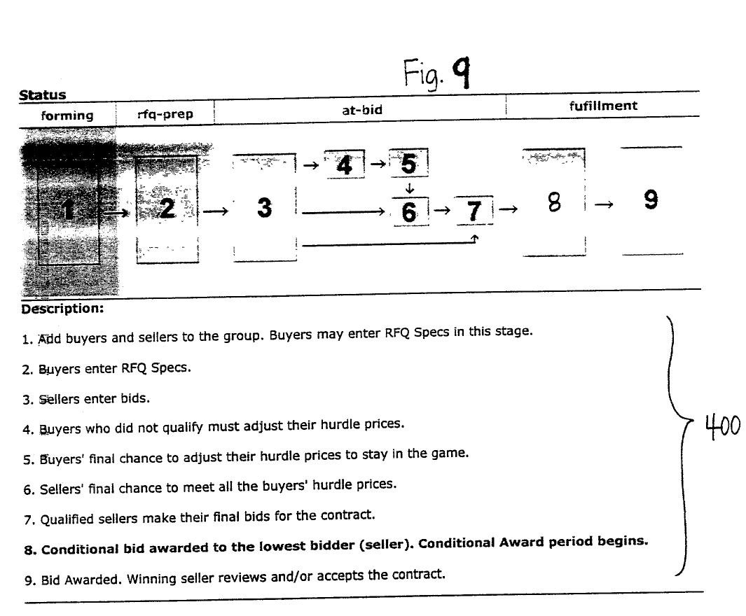

Steps 211 to 213 and 221 to 223 in FIG. 7A may be repeated to qualify the buyers and sellers, respectively. FIGS. 8A-8F illustrate the status and dynamics at each stage of a bidding process in which the buyers and sellers are being qualified. (The status tables shown in FIGS. 8A-8F are not viewable to the members and sellers, but are viewable to the system administrator.)

In stage 1, the buyer group is being formed.

In stage 2, shown in FIG. 8A, the buyers entered RFQ specifications individually and confidentially. They do not have to buy the same products. They only specify the products or services for exactly what they want to buy. Further, they do not loose any pricing advantage they may have had prior to joining the group as hurdle prices enable buyers to improve relative to themselves with no reference to prices paid or savings achieved by other buyers in the group. The individual hurdle prices as well as the total hurdle price ($12,967.46) are shown for the buyers. The buyers have customized their orders to allow them to buy different products as well as different quantities of products with different terms and conditions. The group achieves the value of aggregation without compromising their individuality.

In stage 3, the sellers enter their bids, as shown in FIG. 8B. There are three sellers who currently do not meet the hurdle price for the buyer F (420), two for buyer PG (421), one for buyer RB (422), and three for buyer S (423).

In stage 4, the buyers who did not sufficiently raise their hurdle price in stage 3 (i.e., buyers whose hurdle prices are lower than all the current bids of the sellers) must adjust their hurdle prices (FIG. 8C). In example shown, buyer F raised their hurdle price 426 from $1149.27 to $1,188.90, but it is still too aggressive as no seller has quoted a price that low. (Buyers do not see sellers bids until the conditional award stage as that could disclose a quote lower than needed to satisfy the buyer. System is designed to create significant value for both buyers and sellers); buyer S raised their hurdle price 427, from $1,819.06 to $1904.67, to be lower than at least one of the seller's prices 425 (J Produce).

Stage 5 gives the buyers a final chance to adjust their hurdle prices to stay in the game (FIG. 8D). Since the buyer F has a hurdle price of $1188.90, which is lower than the bids 420 for all the sellers, they raised their hurdle price 428 to $1,196.00, which happened to meet at least the lowest bid 430 of $1,192.62 from Cal Produce. If they have not raised their hurdle price, they will be disqualified from the bidding game. (It is noted that the buyers do not know seller pricing. When they adjust their hurdle price, they simply are setting a level at which they will buy as a member of the group, a number that makes it worth their while.) Buyer S stays in the game because their revised hurdle price of $1904,67 is higher than at least one of the seller's bid (i.e., $1923.00 in this example). It is noted that at this stage, the buyers' total hurdle price of $13,099.79 has not been met yet. It is noted that the system does not check this parameter at this point, only the relationship between each buyer's hurdle and each seller's bid is analyzed and creates cause for action as illustrated above.

In stage 6, the sellers are given a final chance to meet all the buyers' hurdle prices (FIG. 8E). At this point in the game, they now know that at least one seller has met each of the buyers hurdle prices. Since there is at least one seller that met all the buyers' hurdle prices, so the other sellers have to lower their bids as well or exit the game. In the example, we see that there is only one bid 432 of $3486.11 from Cal Produce that has not met buyer PG's hurdle price of $3,382.48.

By stage 7, all sellers have qualified (as shown in FIG. 8F), so qualified sellers make their final bids for the contract. All bids have met the buyers' hurdle prices. The seller with the lowest total bid 434 is M Produce, with a total of $12,494.70; the total buyers' hurdle price 436 is $13,099.79.

As can be appreciate from the above example, there is no “leveling of the playing field” across the members of a group in terms of prices obtained, as seen in the varying hurdle prices of stage 7. One of the factors that may deter group formation is some buyers' concern that their volume may create more benefit for other buyers in the group with lesser volumes, reputations or other factors less attractive to sellers such as distribution costs or contract terms. The present system enables each buyer to improve relative to themselves while maintaining their identity and gaining the advantages of being a member of the group.

Internal Buying Units

Large organizations can create different buying groups made up of buying units internal to their organization in order to create the most practical, advantageous and efficient group buying units at the local, regional, and corporate levels. In other words, instead of having the entire organization as a buyer, the different buying units can independently make decisions and exert control over the buying process, depending on the characteristics of the buying units with respect to, for example, different nature of products and services, different geographical locations, etc. The process is much the same as that described above, but the primary difference is that someone at the corporate level decides what degree of independent decision-making is delegated to each of the buying units. For example, one can allow a unit to change specs or use a standard set. Another option is to allow a buying unit to establish seller qualifier parameters or use those set at the corporate level. Or, one can allow the buying unit to set their own hurdle price and opt in or out of a game, or use a hurdle price set at the corporate level. All of these variables can be independent of one another, again controlled by some overseeing entity such as the corporate purchasing executive. Internal buying units enable the corporate buyer to effectively customize and fine tune the buying process by dividing into buying units, so as to more effectively administer and control buying throughout the organization without unduly imposing purchasing requirements that may not be feasible to realize.

As an example, a fast food restaurant chain may have several buying units at different parts of the country to purchase same produce at different pricing requirements that commensurate with local market conditions. The buying units responsible for the fast food restaurants in Alaska, for example, may have to submit RFQs with higher hurdle prices compared to similar restaurants in California.

In summary, the group initiative of the present invention achieves the following advantages:

Buyer Perspective

a. Confidentially post RFQ's for multiple items in the same product category at the same time without disclosing what they buy to other buyers and without restrictions that other buyers have to buy the same products.

b. Maintain control of all aspects of their groups' activities such as buyers and sellers invited to join, products and services sought, timing, contract lengths and their group's rules and procedures. No third party comes between them and the sellers they invite to participate.

c. Are priced individually and confidentially by each seller. MGB buyers lose no advantages they gained on their own and commit to buy only if their individual savings goal is met by a supplier they have approved.

d. Individually submit their shipping, delivery and contract terms. No attempt is made to get all buyers to conform on these parameters.

e. Create savings without impacting seller margins by aligning and organizing themselves in ways that reduce sellers' costs and supply chain costs while offering sellers huge increments in volume as well.

f. Create and post professional specifications facilitating like-to-like pricing comparisons and efficient dealings among trading partners.

g. Start and join countless groups, widening and deepening the application of their leveraged buying activities due to the tremendous efficiencies gained by the MGB process.

h. Minimize anti-trust concerns due MGB's unique features that all buyers are priced individually and confidentially coupled with technologies and procedures preventing group members from exchanging any sensitive data with one another.

Seller Perspective

a. Price each buyer individually and confidentially based on his or her specifications, contract terms and buying profile. Pricing confidentiality is protected within the group and beyond.

b. See upfront the price it will take to secure each buyer's business. If all sellers bidding the group decline meeting that price the buyer either raises the price or exits the game. Buyers are committed to buy once their saving goal is met.

c. Have all the critical information needed upfront on each buyer in a group as well as group aggregate data so they can quickly decide if they want to vie for the groups' business.

d. Receive professional specifications better insuring like-to-like pricing comparisons.

e. Have the potential to gain tremendous market share with virtually zero sales and marketing expense.

f. Meet buyers saving goals while protecting margins due to cost saving generated by the MGB process and the costs eliminated throughout the supply chain such as geographic clustering or production scheduling of group members.

g. Experience a net gain when they capture the business of a group that includes existing accounts due to the combined value generated by the group.

The process and system of the present invention has been described above in terms of functional modules in block diagram format. It is understood that unless otherwise stated to the contrary herein, one or more functions may be integrated in a single physical device or a software module in a software product, or one or more functions may be implemented in separate physical devices or software modules at a single location or distributed over a network, without departing from the scope and spirit of the present invention.

It is appreciated that detailed discussion of the actual implementation of each module is not necessary for an enabling understanding of the invention. The actual implementation is well within the routine skill of a programmer and system engineer, given the disclosure herein of the system attributes, functionality and inter-relationship of the various functional modules in the system. A person skilled in the art, applying ordinary skill can practice the present invention without undue experimentation.

While the invention has been described with respect to the described embodiments in accordance therewith, it will be apparent to those skilled in the art that various modifications and improvements may be made without departing from the scope and spirit of the invention. For example, the customizable group initiative process can be easily modified to accommodate an open bid environment in which all buyers and/or sellers may see the bids and status. The bidding process may be conducted in a live auction environment, online or offline. Bidding games may be configured for buyers in a group to designate confidential savings goals and allowing the sellers only one opportunity to bid their best price. Accordingly, it is to be understood that the invention is not to be limited by the specific illustrated embodiments, but only by the scope of the appended claims.

1. A method of executing a group initiative, which enables the establishment and control of a group by members of the group, while allowing the personalized requirements of individual members to be maintained as the group pursues the advantages of the collective bargaining power of the group as a whole, said method comprises the step of:
members defining differing positions within the same category of issues to be negotiated with sellers;
members offering said positions for consideration by sellers;
sellers responding individually to the members with counter-offers;
members accepting a counter-offer from a seller that met all the positions of the buyers.
